(19) United States
(12) Patent Application Publication
(10) Pub. No.: US 2018/0194196 A1
(43) Pub. Date: Jul. 12, 2018

(54) SYSTEMS AND METHODS UTILIZING HEAT PUMPS TO RECOVER THERMAL ENERGY FROM EXHAUST GAS

(71) Applicant: GM GLOBAL TECHNOLOGY OPERATIONS LLC, Detroit, MI (US)

(72) Inventors: Daniel J. Shepard, Ann Arbor, MI (US); Lawrence P. Ziehr, Clarkston, MI (US); Eugene V. Gonze, Pickney, MI (US)

(21) Appl. No.: 15/400,487

(22) Filed: Jan. 6, 2017

(51) Int. Cl. B60H 1/02; B60H 1/00; F01P 9/06; F01N 3/20; F01N 3/10; F01N 3/021; F01P 9/02; F02M 26/22; F02B 37/16

(52) U.S. Cl. CPC B60H 1/025; B60H 1/00914; B60H 1/00921; F01P 9/06; F01N 3/2066; F01N 3/103; F01P 2060/18; F01P 9/02; F02M 26/22; F02B 37/16; B60H 2001/00928; F01P 2060/045; F01N 3/021

(57) ABSTRACT

Thermal management systems for a vehicle powered by internal combustion engines (ICEs) are provided. Systems include a coolant circuit configured to circulate a coolant and transfer heat between the coolant and a heat consumer appurtenant to the vehicle, and a refrigerant circuit configured to circulate a refrigerant such that the refrigerant is capable of extracting heat from exhaust gas generated by the ICE and subsequently transferring heat to the coolant. The refrigerant circuit can include one or more of an exhaust gas heat exchanger, a compressor, a coolant heat exchanger, a condenser, and an evaporator. Heat transferred to the coolant via the coolant heat exchanger can be transferred to one or more heat consumers, including the ICE, a turbocharger, an oil heater, a heater core, an exhaust gas recirculation cooler, an axle, a differential, an exhaust gas treatment device, and a reductant reservoir for an SCR or SCRF device.

### INTRODUCTION

Many vehicles are powered by internal combustion engines (ICEs) which combust air/fuel mixtures within combustion chambers to provide output torque. ICEs generate heat during operation, and coolant is commonly used to transfer thermal energy from the ICE to a radiator or heater core. A heater core can be used to heat the cabin of the vehicle. Vehicles also commonly utilize air-conditioning systems to cool the cabin of the vehicle by transferring thermal energy from within the vehicle cabin to the ambient, which in many instances is hotter than the cabin. The heater core and air-conditioning heat pump are commonly used in combination with a blower, and are collectively referred to as a heating, ventilation and air conditioning (HVAC) system. Thermal management of various vehicle systems remains a challenge.

### SUMMARY

According to an aspect of an exemplary embodiment, a thermal management system for a vehicle powered by an internal combustion engine (ICE) and an exhaust gas system including an exhaust gas conduit capable of accepting exhaust gas from the ICE is provided. The system can include a coolant circuit configured to circulate a coolant and transfer heat between the coolant and a heat consumer appurtenant to the vehicle, and a refrigerant circuit configured to circulate a refrigerant such that the refrigerant is capable of extracting heat from the exhaust gas system and subsequently transferring heat to the coolant. The system can further comprise a heat exchanger configured to facilitate heat transfer from the refrigerant to the coolant, and a heat exchanger configured to facilitate heat transfer from the exhaust gas to the refrigerant. The system can further comprise a compressor for compressing the refrigerant prior to transferring heat from the refrigerant to the coolant. The exhaust system can include an exhaust gas treatment device, and heat is transferred from the exhaust gas to the refrigerant downstream from the exhaust gas treatment device. The ICE can be a diesel ICE. The heat consumer appurtenant to the vehicle can comprise one or more of an ICE, a turbocharger, an ICE oil heater, a transmission oil heater, a heater core, an exhaust gas recirculation cooler, a differential heating device, and an exhaust gas treatment device.

According to an aspect of an exemplary embodiment, a thermal management system for a vehicle powered by an ICE is provided. The system can include a coolant circuit configured to circulate a coolant between a coolant heat exchanger, the ICE, and a heat consumer appurtenant to the vehicle, and a refrigerant circuit configured to circulate refrigerant between an exhaust gas heat exchanger in thermal communication with exhaust gas provided by the ICE, the coolant heat exchanger, and one or more of a condenser, a thermal expansion valve or an orifice tube, and an evaporator. The refrigerant circuit can further comprise a compressor in fluid communication with the coolant heat exchanger, the exhaust gas heat exchanger, and at least one of the condenser, the thermal expansion valve, and the evaporator. The system can further comprise a compressor bypass. The exhaust gas can be less than about 250° C. immediately prior to thermal communication with the refrigerant. The coolant circuit can be configured such that coolant can be selectively circulated between the coolant heat exchanger and the ICE to transfer heat from the refrigerant to the ICE via the coolant, or between the ICE and the heat consumer to transfer heat from the ICE to the heat consumer via the coolant. The coolant circuit can be configured such that coolant can be selectively circulated between the coolant heat exchanger and one or more of the ICE and the heat consumer to transfer heat from the refrigerant to one or more of the ICE and the heat consumer via the coolant, or between the ICE and the heat consumer to transfer heat from the ICE to the heat consumer via the coolant.

According to an aspect of an exemplary embodiment, a thermal management system for a vehicle powered by an ICE is provided. The system can include a coolant circuit configured to circulate a coolant between a coolant heat exchanger and the ICE, and a refrigerant circuit comprising an air conditioning circuit in fluid communication with a heating circuit. The air conditioning circuit can include a compressor, a condenser, and an evaporator, and the heating circuit can include an exhaust gas heat exchanger in thermal communication with exhaust gas provided by the ICE, the compressor and the coolant heat exchanger. The refrigerant circuit is capable of circulating refrigerant through each of the heating circuit and the air conditioning circuit, and the refrigerant is capable of extracting heat from the exhaust gas and subsequently transferring heat to the coolant. The refrigerant circuit can be selectively configured to circulate refrigerant through only one of the heating circuit or the air conditioning circuit. The refrigerant circuit can be selectively configured to circulate refrigerant through both of the heating circuit and the air conditioning circuit. The air conditioning circuit can further comprise a thermal expansion valve, or an orifice tube. The exhaust gas is less than about 250° C. immediately prior to thermal communication with the refrigerant. The coolant circuit can further comprise a heat consumer appurtenant to the vehicle at least in thermal communication with the coolant.

Although many of the embodiments herein are describe in relation to thermal management of diesel engine-powered vehicles, or vehicles which generate “low quality” exhaust, the embodiments herein are generally suitable for all vehicles, including those powered by gasoline engines. Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a schematic for a vehicular thermal management system, according to one or more embodiments.

### DETAILED DESCRIPTION

Embodiments of the present disclosure are described herein. It is to be understood, however, that the disclosed embodiments are merely examples and other embodiments can take various and alternative forms. The FIGURES are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the FIGURES can be combined with features illustrated in one or more other FIGURES to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are vehicle thermal management systems which integrate heating, ventilation and air conditioning (HVAC) heat pump systems with internal combustion engine (ICE) coolant systems and are configured to transfer heat from vehicle exhaust gas to the ICE of the vehicle and/or one or more additional appurtenant heat consumers appurtenant to the vehicle. Such thermal management systems can be advantageously utilized in particular situations such as cold starts, and can improve the efficiency, longevity, and/or operation of one or more systems of the vehicle. As used to herein, a “cold start” refers to starting an engine when it is at or near ambient temperature. In some embodiments, “cold start” refers to starting an engine while the engine is at a temperature below the desired or normal operating temperature of the engine. For example, transferring heat from exhaust gas to the ICE of a vehicle during a cold start can improve the fuel economy and/or efficiency of the ICE. In another example, transferring heat from exhaust gas to an exhaust gas treatment device during a cold start can decrease the time required for the device to achieve its “light-off” temperature, as will be described below. In another example, transferring heat from exhaust gas to a turbocharger during a cold start can increase the durability and longevity of the turbocharger bearings.

Heat extraction, particularly from vehicle exhaust gases, typically utilizes passive heat transfer concepts which rely on gravity and the temperature differential (ΔT) between a coolant and the exhaust gas to recover thermal energy (i.e., heat) from a warmer location to a colder location. In most instances, a minimum ΔT between the heat transfer medium and the thermal source must exist for efficient and/or worthwhile transfer of heat. Conversely, a heat pump system can be utilized, as described herein, to recover heat from a cold location and transfer the same to a relatively warmer location. In such instances, heat is not conserved and the heat pump requires external energy to effect the heat transfer (e.g., electricity to power a compressor).

In general, a heat pump circulates a refrigerant between a compressor, a condenser, and an evaporator. Such heat pumps typically constitute the air-conditioning portion of HVAC systems in vehicles. During operation of a heat pump, refrigerant is compressed into a hot, pressurized vapor, which is subsequently cooled and condensed in the condenser. The refrigerant absorbs heat and vaporizes in the evaporator before returning to the compressor. The evaporator can cool air supplied by a blower which can be used to condition a vehicle cabin, for example. A HVAC system generally additionally includes a heater core, which is thermally integrated with the vehicle ICE via coolant. The coolant is generally used to extract heat from the ICE, and transfer heat to air supplied by the blower at the heater core. The hot air can be used to heat the vehicle cabin, for example. The coolant can also transfer heat to the ambient via a radiator in instances where heat is generally in excess across some or most vehicular systems.

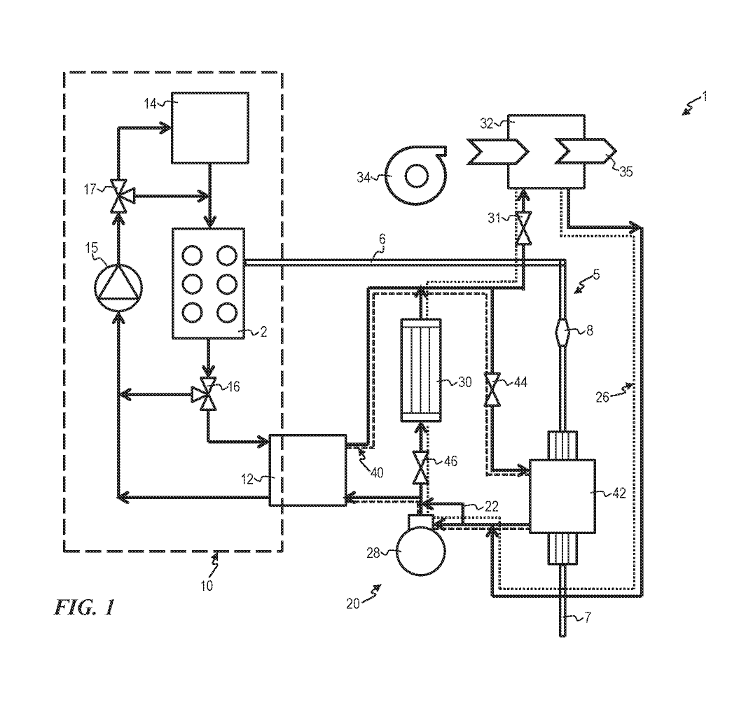

FIG. 1 illustrates an ICE thermal management system 1, which includes ICE 2. ICE 2 can comprise a diesel engine system or a gasoline engine system, and can generally include any number of cylinder arrangements and a variety of reciprocating engine configurations including, but not limited to, V-engines, inline engines, and horizontally opposed engines, as well as both overhead cam and cam-in-block configurations. ICE 2 can be any engine configuration or application, including various vehicular applications (e.g., automotive, marine and the like), although other various non-vehicular applications (e.g., pumps, generators and the like) are germane to the scope of this disclosure.

ICE 2 generally includes a plurality of pistons (not shown) configured to reciprocate within the cylinders (not shown) of an engine block (not shown), the pistons being attached to a crankshaft (not shown) which can be operably attached to a driveline, such as a vehicle driveline (not shown), to deliver power to the driveline. Combustion chambers (not shown) are defined within the cylinders between a bottom surface of a cylinder head (not shown) and the top of an associated piston configured to reciprocate within the cylinder. The combustion chambers are configured to receive a fuel-air mixture for subsequent combustion therein. Air is provided to the cylinders via an intake manifold (not shown). Combustion creates an exhaust gas which is communicated to an exhaust system 5 which includes a tailpipe 6 for expelling the exhaust gas. Exhaust gas generally comprises a mixture of gaseous, liquid, and solid species, in addition to heat.

System 1 utilizes a heat pump to extract heat from exhaust gas generated by ICE 2. In particular, system 1, and disclosed permutations thereof, can be advantageously utilized to diesel ICEs, or other ICEs which similarly generate low quality exhaust gas, to extract heat from the generated exhaust gas. Low quality exhaust can be defined as exhaust which is less than about 275° C., less than about 250° C., less than about 225° C., or less than about 200° C. The temperature of the exhaust gas can be measured at the ICE discharge, or proximate the location at which heat is extracted therefrom. For example, the temperature of the exhaust gas can be defined immediately prior to thermal communication with the refrigerant (e.g., within an exhaust gas heat exchanger, as described below). In some embodiments, system 1 can be utilized to extract heat from exhaust gas generated by ICEs which normally generate high quality exhaust gas (e.g., exhaust gas above about 300° C.) during periods in which exhaust gas can be considered low quality.

As shown in FIG. 1, system 1 includes an exhaust system 5 which includes a conduit 6 or like structure for fluidly communicating exhaust gas to a tailpipe where the exhaust gas is expelled. Exhaust system 5 can further include one or more exhaust gas treatment devices 7 which are used, for example, to remove or alter various species within the exhaust gas. Device 7 can comprise an oxidation catalyst device (e.g., a “DOC), a selective catalytic reduction (SCR) device, a particulate filter device (e.g., a “DPF”), or a selective catalytic reduction filter (SCRF) device, among others. Many such exhaust gas treatment devices are not efficacious (e.g., catalytically active) below a particular “light-off” temperature, and/or require a certain level of heat (e.g., supplied by the exhaust gas or other heat source) to operate as desired. Accordingly, in some embodiments wherein exhaust system 5 includes an exhaust gas treatment device, system 1 can extract heat from the exhaust gas downstream from the exhaust gas treatment device. Such a configuration can further benefit the heat pump in some instances by minimizing or preventing refrigerant oil migration issues which occur at higher temperatures, such as above about 350° C., for example.

As shown in FIG. 1, system 1 includes a coolant circuit 10 configured to circulate a coolant between ICE 2, coolant heat exchanger 12, and optionally heat consumer 14. Circulating coolant between ICE 2, coolant heat exchanger 12, and optionally heat consumer 14 can be defined as, at a minimum, establishing thermal communication between the coolant and said devices. In some instances, fluid communication is established between the coolant and said devices. Circulating coolant through ICE 2 can comprise establishing thermal communication between the coolant and one or more of the engine block, the engine head, or an integrated exhaust manifold (not shown) of ICE 2. Heat consumer 14 can comprise one or more of a turbocharger, an ICE oil heater, a transmission oil heater, a heater core, an exhaust gas recirculation cooler, a differential heating device, an exhaust gas treatment device, and a reductant (e.g., urea) reservoir for an SCR or SCRF device. In some embodiments, heat consumers can additionally or alternatively include a charge air cooling system, an evaporative emissions canister, a transfer case, or a windshield washer fluid reservoir.

Coolant can be circulated by one or more pumps, such as pump 15, for example. Coolant can be circulated through coolant circuit 10 via conduit, pipe, hose, or other like means. The location of pump 15 within the coolant circuit 10 is not restricted to the location as shown, and can be differently oriented as desired by one of skill in the art to effect suitable circulation of coolant within coolant circuit 10. In some embodiments, coolant circuit 10 can further include one or more valves, such as valves 16 and 17, to selectively circulate coolant as desired. For example, as shown, valves 16 and 17 can be used to circulate coolant only between ICE 2 and coolant heat exchanger 12, or only between ICE 2 and heat consumer 14. The former orientation can achieve a maximum heat transfer to the ICE 2 (e.g., during a cold start), and the latter can achieve a heat transfer away from the ICE 2 (e.g., during normal operation where it is desired to cool ICE 2.) Other orientations of valves 16 and 17, including orientations which include additional valves, are within the scope of this disclosure and can be utilized, as will be understood by one of skill in the art, to achieve heat transfer to multiple heat consumers 14 as desired.

System 1 further comprises a refrigerant circuit 20, which includes an air conditioning circuit 26 and a heating circuit 40. Air conditioning circuit 26 is configured to circulate refrigerant between a compressor 28, a condenser 30, and an evaporator 32. Compressor 28 can be belt driven by the ICE, for example. Condenser 30 can be water-cooled, for example. As described above, air conditioning circuit 26 can be utilized with a blower 34 to blow air 35 across the evaporator 32 to deliver cool air 35 to a vehicle cabin, for example. Air conditioning circuit 26 can further comprise a thermal expansion valve (TXV) 31 to reduce the temperature and pressure of the refrigerant prior to the evaporator 32. An orifice tube or other like device can be used in place of TXV 31, in some embodiments.

Heating circuit 40 is configured to circulate refrigerant between an exhaust gas heat exchanger 42 and the coolant heat exchanger 12. Exhaust gas heat exchanger 42 is in thermal communication with exhaust gas generated by ICE 2 and the refrigerant, and is configured to extract heat from the exhaust gas and transfer the same to the refrigerant. The refrigerant can subsequently circulate through the coolant heat exchanger 12 and transfer heat to the coolant. Heating circuit 40 can further include compressor 28. Compressor can increase the temperature and/or pressure of the refrigerant before the latter is circulated through the coolant heat exchanger 12. Heating circuit 40 can further include an electronic expansion valve (EXV) 44.

Air conditioning circuit 26 can be selectively configured to circulate refrigerant only through air conditioning circuit 26, only through heating circuit 40, or simultaneously through air conditioning circuit 26 and heating circuit 40. In one embodiment, when ICE 2 is being cold-started and it is desired to provide heat to ICE 2, refrigerant is only circulated through heating circuit 40. In one embodiment, when the ICE 2 has achieved a desired operating temperature, or is at a temperature above a described operating temperature, refrigerant is only circulated through the air conditioning circuit 26. In one embodiment, when ICE 2 is being cold-started and it is desired to both provide heat to ICE 2 and operate a windshield defroster (e.g., provide conditioned air via blower 34), refrigerant is circulated simultaneously through air conditioning circuit 26 and heating circuit 40. Air conditioning circuit 26 can optionally include one or more valves, such as valve 46 to effect the aforementioned or other refrigeration circulation strategies as desired.

Refrigerant circuit 20 can optionally include a compressor bypass 22, and can circulate refrigerant within air conditioning circuit 26 and heating circuit 40. Bypass 22 be utilized to reduce or eliminate energy usage by the compressor. For example, utilizing the compressor bypass 22 can be appropriate where a sufficient ΔT is observed between the refrigerant and the coolant in order to suitably transfer heat. A sufficient ΔT is dependent upon various factors including the heat capacities of the refrigerant and the coolant, the heat transfer characteristics of the coolant heat exchanger 12, ambient temperature, exhaust gas temperature, and a target ICE 2 heating temperature, among others.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A thermal management system for a vehicle powered by an internal combustion engine (ICE) and an exhaust gas system including an exhaust gas conduit capable of accepting exhaust gas from the ICE, the thermal management system comprising:
a coolant circuit configured to circulate a coolant and transfer heat between the coolant and a plurality of heat consumers appurtenant to the vehicle, wherein the plurality of heat consumers comprise an ICE and one or more of a turbocharger, an ICE oil heater, a transmission oil heater, a heater core, an exhaust gas recirculation cooler, a differential heating device, and an exhaust gas treatment device; and
a refrigerant circuit configured to circulate a refrigerant such that the refrigerant is capable of extracting heat from the exhaust gas system and subsequently transferring heat to the coolant,
wherein the coolant circuit is configured such that the coolant can selectively circulated to transfer heat from the refrigerant to the ICE via the coolant, or to transfer heat from the ICE to a different heat consumer via the coolant.

2. The system of claim 1, further comprising a heat exchanger configured to facilitate heat transfer from the refrigerant to the coolant.

3. The system of claim 1, further comprising a heat exchanger configured to facilitate heat transfer from the exhaust gas to the refrigerant.

4. The system of claim 1, further comprising a compressor for compressing the refrigerant prior to transferring heat from the refrigerant to the coolant.

5. The system of claim 1, wherein the exhaust system includes an exhaust gas treatment device, and heat is transferred from the exhaust gas to the refrigerant downstream from the exhaust gas treatment device.

6. The system of claim 5, wherein the exhaust gas treatment device comprises a selective catalytic reduction device, a selective catalytic reduction filter device, a particulate filter device, or an oxidation catalyst device.

7. The system of claim 1, wherein the ICE is a diesel ICE.

8. (canceled)

9. A thermal management system for a vehicle powered by an internal combustion engine (ICE), the system comprising:
a coolant circuit configured to circulate a coolant between a coolant heat exchanger, the ICE, and a heat consumer appurtenant to the vehicle; and
a refrigerant circuit configured to circulate refrigerant between an exhaust gas heat exchanger in thermal communication with exhaust gas provided by the ICE, the coolant heat exchanger, and one or more of a condenser, a thermal expansion valve or an orifice tube, and an evaporator.

10. The system of claim 9, wherein the refrigerant circuit further comprising a compressor in fluid communication with the coolant heat exchanger, the exhaust gas heat exchanger, and at least one of the condenser, the thermal expansion valve, and the evaporator.

11. The system of claim 10, further comprising a compressor bypass.

12. The system of claim 9, wherein the exhaust gas is less than about 250° C. immediately prior to thermal communication with the refrigerant.

13. The system of claim 9, wherein the coolant circuit is configured such that coolant can be selectively circulated between the coolant heat exchanger and the ICE to transfer heat from the refrigerant to the ICE via the coolant, or between the ICE and the heat consumer to transfer heat from the ICE to the heat consumer via the coolant.

14. The system of claim 9, wherein the coolant circuit is configured such that coolant can be selectively circulated between the coolant heat exchanger and one or more of the ICE and the heat consumer to transfer heat from the refrigerant to one or more of the ICE and the heat consumer via the coolant, or between the ICE and the heat consumer to transfer heat from the ICE to the heat consumer via the coolant.

15. A thermal management system for a vehicle powered by an internal combustion engine (ICE), the system comprising:
a coolant circuit configured to circulate a coolant between a coolant heat exchanger and the ICE; and
a refrigerant circuit comprising an air conditioning circuit in fluid communication with a heating circuit, wherein the air conditioning circuit includes a compressor, a condenser, and an evaporator, and the heating circuit includes an exhaust gas heat exchanger in thermal communication with exhaust gas provided by the ICE, the compressor and the coolant heat exchanger, wherein the refrigerant circuit is capable of circulating refrigerant through each of the heating circuit and the air conditioning circuit, and the refrigerant is capable of extracting heat from the exhaust gas and subsequently transferring heat to the coolant.

16. They system of claim 15, wherein the refrigerant circuit can be selectively configured to circulate refrigerant through only one of the heating circuit or the air conditioning circuit.

17. They system of claim 15, wherein the refrigerant circuit can be selectively configured to circulate refrigerant through both of the heating circuit and the air conditioning circuit.

18. They system of claim 15, wherein the air conditioning circuit further comprises a thermal expansion valve, or an orifice tube.

19. They system of claim 15, wherein the exhaust gas is less than about 250° C. immediately prior to thermal communication with the refrigerant.

20. The system of claim 15, wherein the coolant circuit further comprises a heat consumer appurtenant to the vehicle at least in thermal communication with the coolant.
